(19) United States
(12) Patent Application Publication
(10) Pub. No.: US 2009/0153935 A1
(43) Pub. Date: Jun. 18, 2009

(54) ACTUATOR

(76) Inventor: Osamu Kajino, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 11/568,137

(22) PCT Filed: Apr. 14, 2005
(86) PCT No.: PCT/JP2005/007257

§ 371 Date: Oct. 20, 2006

(30) Foreign Application Priority Data
Apr. 22, 2004 (JP) 2004-126591

(51) Int. Cl. G02B 26/00; H02N 2/04

(52) U.S. Cl. 359/221.2; 310/331

(57) ABSTRACT

An actuator according to the present invention includes: a base 1; a movable section 7 capable of displacement relative to the base 1; elastic supporting members 13a to 13c for supporting the movable section 7 so as to allow the movable section 7 to make a displacement relative to the base 1; and a plurality of driving sections 6a to 6c for causing the movable section 7 to be displaced relative to the base 1. The plurality of driving sections 6a to 6c respectively include driving force transmitting sections 10a to 10c which come in contact with the movable section when transmitting driving force to the movable section 7.

### TECHNICAL FIELD

The present invention relates to a actuator capable of tilt and vertical displacement. The actuator of the present invention is used as, for example, a micromirror device having a light reflecting surface on a movable section thereof.

### BACKGROUND ART

Various microactuators have been produced by using MEMS (Micro Electro Mechanical System) techniques, and applications of microactuators to various fields such as optics, high-frequency circuits, and biotechnology are expected. For example, in the field of adaptive optics, micromirror arrays for controlling the wave front of light are being developed. Moreover, for example, micromirror arrays to be used as mechanical optical switches for reflecting a light beam so as to enter a photoelectric device or an optical fiber are being developed.

Such a micromirror array includes a plurality of actuators. It is desirable that a mirror which is comprised by each actuator is capable of having a bi-axial tilt in order to cause incident light to be reflected in an arbitrary direction.

With reference to FIG. 11, a conventional actuator which is disclosed in Patent Document 1 is described. FIG. 11 shows an actuator 200 which comprises a mirror and functions as a mirror driving device.

A light reflecting surface 102 is provided on a portion of a spherical mirror 101. Four arms 104 of a frame 103 (one of which is not shown) retain the spherical mirror 101. A spherical dent (not shown) is formed in each portion of the arm 104 that contacts the spherical mirror 101. Since the arms 104 fit on the spherical mirror 101 to retain the spherical mirror 101, the spherical mirror 101 is capable of pivoting independently around the x axis and around the y axis, and the spherical mirror 101 is prevented from being disengaged from the arms 104 during pivoting of the spherical mirror 101. On the frame 103, four piezoelectric elements 105 are affixed in a 2×2 array. Columnar rods 106 are affixed to the piezoelectric elements 105 at their feet, with their tips being in light contact with the surface of the spherical mirror 101 at a predetermined angle. Each tip of the rod 106 is obliquely cut so as to provide a large contact area with the spherical mirror 101.

When the piezoelectric elements 105 are driven, the tips of the rod 106 are pressed against the surface of the spherical mirror 101 at a predetermined angle. The spherical mirror 101 is retained by the arms 104, and cannot translate along the Z axis direction, but can only pivot around the X axis and the Y axis. Therefore, the force of the rods 106 pushing the spherical mirror 101 acts so as to pivot the spherical mirror 101. By selecting which piezoelectric element 105 to drive, the spherical mirror 101 can be pivoted around either the x axis or the y axis, whereby the light reflecting surface 102 can be tilted in any arbitrary direction.

Since the outer shape of the frame 103 is a rectangular solid, it is possible to efficiently dispose mirrors of similar structures in up/down/left/right directions.

However, the conventional actuator 200 has a problem in that the rod 106 and the spherical mirror 101 are abraded through use over long periods of time. There is also a problem in that the surface of the spherical mirror 101 needs to be processed into a highly accurate sphere.

When the rods 106 cause the spherical mirror 101 to pivot, if the rods 106 come in contact with the surface of the spherical mirror 101 at a near-perpendicular angle, the force which is in the direction of pivoting the spherical mirror 101 is reduced, thus making it impossible for the spherical mirror 101 to pivot. Therefore, it is necessary that the contact of the rods 106 occur with a large angle relative to the direction which is perpendicular to the surface of the spherical mirror 101. However, in this case, a phenomenon is likely to occur: the rods 106 may slip and rub on the surface without causing the spherical mirror 101 to pivot, thus causing abrasion of the rods 106 and the surface of the spherical mirror 101. Moreover, while a given rod 106 is causing the spherical mirror 101 to pivot, the other rods 106 are rubbing on the surface of the spherical mirror 101, the rods 106 and the spherical mirror 101 will be abraded through long hours of use. Therefore, the initial characteristics cannot be maintained, whereby the reliability of the actuator 200 is lowered.

Moreover, in the case where the surface of the spherical mirror 101 is not a highly accurate sphere, the state of contact between the spherical mirror 101 and the rods 106 changes due to pivoting, thus resulting in problems such as a decrease in the friction force between the spherical mirror 101 and the rod 106. This results in slipping and makes it impossible to perform driving. Therefore, it is necessary to process the spherical mirror 101 into a highly accurate sphere, which will lead to high cost. Furthermore, in the case of a very small micromirror utilizing a MEMS technique, processing the outer shape of the mirror into a sphere is in itself very difficult.

Moreover, although the actuator 200 only causes the spherical mirror 101 to tilt, in order to control the wave front of light more smoothly, it would be desirable to cause the spherical mirror 101 to make a vertical displacement while also tilting with respect to the frame 103.

An example of an actuator which is capable of such tilt and vertical displacement is disclosed in Non-patent Document 1. FIG. 12 is a perspective view schematically showing a microactuator 300 which is disclosed in Non-patent Document 1.

A movable electrode 305 is supported by three elastic beams 301a, 301b and 301c at its outer periphery portion. Moreover, the movable electrode 305 opposes three stationary electrodes 302a, 302b and 302c. The movable electrode 305 and the stationary electrodes 302a, 302b and 302c compose three driving sections. A mirror 303 is rigidly coupled to the movable electrode 305 at an attachment section 304. In other words, the mirror 303 is rigidly coupled to the three driving sections.

The stationary electrode 302a, 302b and 302c are provided in such a manner that driving voltages can be independently applied thereto, so as to acquire a potential difference with respect to the movable electrode 305. As a result, an electrostatic force is generated in a direction of pulling the movable electrode 305. By setting the same driving voltage for the stationary electrodes 302a to 302c, the movable electrode 305 makes a vertical displacement in the lower direction, without hardly any tilt. Moreover, by differentiating these driving voltages, the movable electrode 305 is caused to make a vertical displacement in the lower direction, while tilting in a desired direction. Thus, the movable electrode 305 is capable of making a vertical displacement in the lower direction together with a bi-axial tilt.

Since the mirror 303 is rigidly coupled to the movable electrode 305, the displacement of the movable electrode 305 in itself determines the displacement of the mirror 303.

[Patent Document 1] Japanese Laid-Open Patent Publication No. 7-113967

[Non-patent Document 1] U.Srinivasan, et al., “Fluidic Self-Assembly of Micromirrors Onto Microactuators Using Capillary Forces”, IEEE Journal on Selected Topics in Quantum Electronics, Vol. 8, No. 1, pp. 4-11 (January, 2002)

### DISCLOSURE OF INVENTION

### Problems to be Solved by the Invention

However, the aforementioned microactuator 300 has a problem in that crosstalk may occur between the driving sections. For example, if a predetermined voltage is applied to a given stationary electrode so that an end of the movable electrode 305 opposed by that stationary electrode is displaced along the vertical direction, the end portions of the movable electrode 305 opposed by the other stationary electrodes will also be displaced along the vertical direction.

From the standpoint of posture control of the movable electrode 305, such crosstalk between driving sections should be as small as possible. If the degree of crosstalk is sufficiently small relative to the target resolution of the displacement, the displacements of the respective end portions of the movable electrode 305 opposed by the stationary electrodes 302a to 302c can be independently controlled based on the voltages applied to the corresponding stationary electrodes, so that the controlling device may have a simple structure. In the case of performing a control of correcting for the displacement due to crosstalk, too, it is easier to enhance the accuracy and simplicity of control as the degree of crosstalk becomes smaller. Especially in the case of electrostatic driving, where the driving force can only occur in a pulling direction, it is difficult to perform a correction control in a direction of counteracting the displacement due to crosstalk. Moreover, in the case where there are large variations in the microactuator characteristics, the amount of data for correcting for the displacement due to crosstalk will become enormous. Especially if a device (e.g., a micromirror array) having a large number of microactuators has a large crosstalk, the amount of data for correcting for the displacement due to crosstalk will become enormous. This may cause a tremendous increase in cost and a decrease in the driving speed of the microactuator. In these aspects, it is desirable that the crosstalk between driving sections be small.

The present invention has been made in view of the aforementioned problems, and an objective thereof is to provide an actuator which has little crosstalk between driving sections and which has a high reliability with low cost, and a device incorporating such an actuator.

### Means for Solving the Problems

An actuator according to the present invention comprises: a base; a movable section capable of displacement relative to the base; an elastic supporting member for supporting the movable section so as to allow the movable section to make a displacement relative to the base; and a plurality of driving sections for causing the movable section to be displaced relative to the base, wherein, each of the plurality of driving sections includes a driving force transmitting section which comes in contact with the movable section when transmitting driving force to the movable section.

In one embodiment, the driving force transmitting section is away from the movable section when not transmitting the driving force to the movable section.

In one embodiment, the driving force transmitting section is in slidable contact with the movable section when transmitting the driving force to the movable section.

In one embodiment, the driving force transmitting section includes a protruding portion which comes in contact with the movable section when transmitting the driving force to the movable section.

In one embodiment, the protruding portion is shaped so as to have a cross-sectional area which decreases toward a contact region of the movable section that comes in contact with the protruding portion.

In one embodiment, the movable section includes an intermediate member provided on a side of the movable section opposing the base, the intermediate member coming in contact with the protruding portion when the driving force is transmitted to the movable section, and at least one of the protruding portion and the intermediate member includes a sticking prevention film.

In one embodiment, the movable section includes an intermediate member provided on a side of the movable section opposing the base, the intermediate member coming in contact with the protruding portion when the driving force is transmitted to the movable section, and the movable section further includes a light reflecting surface provided on a side of the movable section opposite from the intermediate member.

In one embodiment, the movable section includes an intermediate member provided on a side of the movable section opposing the base, the intermediate member coming in contact with the protruding portion when the driving force is transmitted to the movable section, and the movable section is displaced when the protruding portion presses the intermediate member in a direction toward the base.

In one embodiment, the movable section further includes a light reflecting surface provided on a side of the movable section opposite from the intermediate member, and the protruding portion is located between the light reflecting surface and the intermediate member.

In one embodiment, the driving force transmitting section further includes: post portions sandwiching a portion of the intermediate member with an interspace from the intermediate member; and a bridge portion located between the light reflecting surface and the intermediate member and being supported by the post portions, and the protruding portion is provided on the bridge portion.

A device according to the present invention comprises: a base; a plurality of movable sections capable of displacement relative to the base; a plurality of elastic supporting members for each supporting a corresponding one of plurality of movable sections so as to allow the movable section to make a displacement relative to the base; and a plurality of driving sections for causing respective ones of the plurality of movable sections to be displaced relative to the base, wherein, each of the plurality of driving sections includes a driving force transmitting section which, when transmitting driving force to a corresponding one of the plurality of movable sections, comes in contact with the corresponding movable section.

### Effects of the Invention

According to the present invention, the driving sections include driving force transmitting sections which come in contact with the movable section when transmitting driving force to the movable section. In other words, each driving force transmitting section is not rigidly coupled to the movable section. Therefore, when the movable section is displaced by a given driving force transmitting section, displacement of any other driving force transmitting section is suppressed, thus making the crosstalk between driving sections very small.

Moreover, according to the present invention, a highly reliable actuator can be provided which has an inexpensive structure that does not require a highly accurate spherical mirror, and which is free of abrasion of its constituent elements.

### BRIEF DESCRIPTION OF DRAWINGS

FIG. 1 An exploded perspective view schematically showing an actuator according to an embodiment of the present invention.

FIG. 2 An exploded perspective view schematically showing an actuator array according to an embodiment of the present invention.

FIG. 3 An exploded perspective view schematically showing stationary electrodes and yokes according to an embodiment of the present invention.

FIG. 4 An exploded perspective view schematically showing an intermediate member, elastic supporting members and driving force transmitting sections according to an embodiment of the present invention.

FIG. 5 A cross-sectional view schematically showing an intermediate member and protruding portions according to an embodiment of the present invention.

FIG. 6A An upper plan view of an actuator according to an embodiment of the present invention.

FIG. 6B A cross-sectional view of an actuator taken along line 6B-6B shown in FIG. 6A.

FIG. 7A An upper plan view of an actuator according to an embodiment of the present invention.

FIG. 7B A cross-sectional view of an actuator taken along line 7B-7B shown in FIG. 7A.

FIG. 8A A cross-sectional view of an actuator taken along line 6B-6B shown in FIG. 6A.

FIG. 8B A cross-sectional view of an actuator taken along line 7B-7B shown in FIG. 7A.

FIG. 9A A cross-sectional view of an actuator taken along line 6B-6B shown in FIG. 6A.

FIG. 9B A cross-sectional view of an actuator taken along line 7B-7B shown in FIG. 7A.

FIG. 10A A cross-sectional view of an actuator in which an intermediate member and yokes are rigidly coupled.

FIG. 10B A cross-sectional view of an actuator in which an intermediate member and yokes are rigidly coupled.

FIG. 11 A perspective view showing a conventional actuator.

FIG. 12 A perspective view showing a conventional actuator.

### DESCRIPTION OF THE REFERENCE NUMERALS

1 base
2 mirror
4a, 4b, 4c stationary electrodes
5a, 5b, 5c yokes
6a, 6b, 6c driving sections
7 movable section
10a, 10b, 10c driving force transmitting sections
11 intermediate member
12a, 12b, 12c contacted portions
13a, 13b, 13c elastic supporting members
14 mirror post
31a, 31b, 31c bridge portions
32a, 32b, 32c, 33a, 33b, 33c post portions
34a, 34b, 34c protruding portions
40 sticking prevention film

### BEST MODE FOR CARRYING OUT THE INVENTION

Hereinafter, embodiments of an actuator according to the present invention and a device incorporating such an actuator will be described with reference to the drawings.

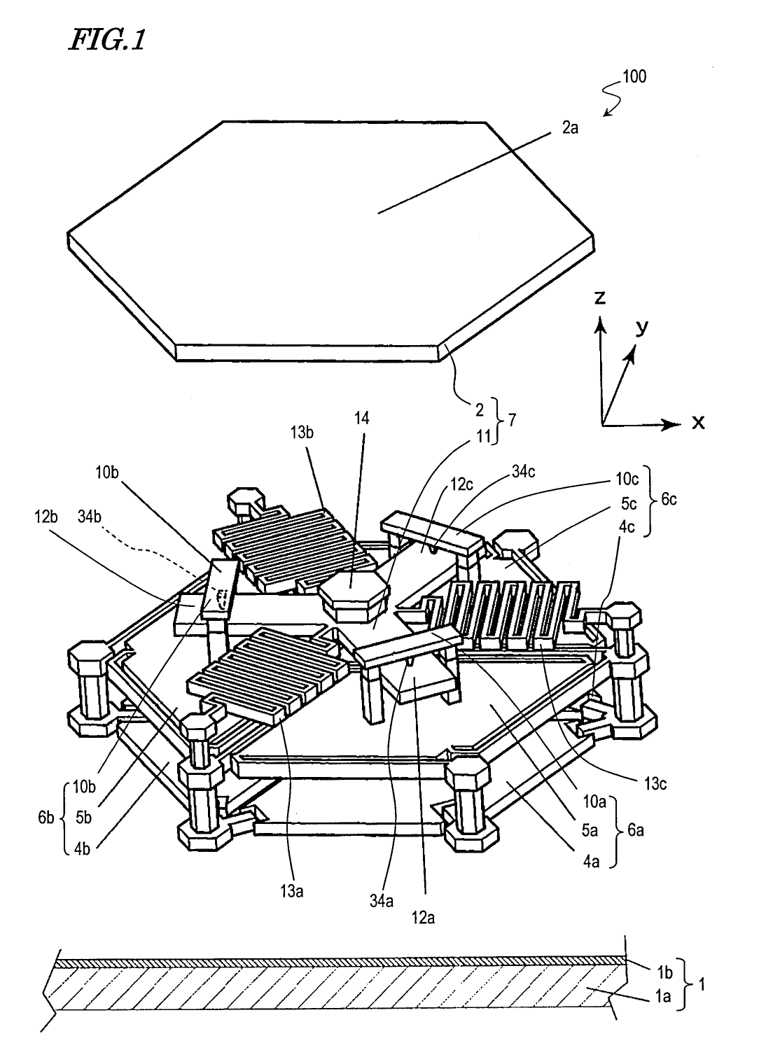

First, FIG. 1 is referred to. FIG. 1 is an exploded perspective view schematically showing an actuator 100 according to the present embodiment. The actuator 100 is produced by using a micromachining technique or a MEMS technique utilizing a semiconductor fabrication process.

The actuator 100 comprises a base 1, a movable section 7 which is capable of making a displacement relative to the base 1, elastic supporting members 13a, 13b and 13c which support the movable section 7 in such a manner that the movable section 7 is capable of making a displacement relative to the base 1, and a plurality of driving sections 6a, 6b and 6c for causing the movable section 7 to be displaced relative to the base 1.

The base 1 includes a silicon member 1a and an insulating layer 1b of a silicon nitride-type formed on the silicon member 1a. A driving circuit (not shown) is formed on the silicon member 1a. Driving sections 6a to 6c are provided on the insulating layer 1b. Vias (not shown) are formed in the insulating layer 1b, so that the driving circuit is electrically connected to the driving sections 6a to 6c through the vias. The driving sections 6a, 6b and 6c include driving force transmitting sections 10a, 10b and 10c for transmitting driving forces to the movable section 7. The driving force transmitting sections 10a, 10b and 10c include protruding portions 34a, 34b and 34c which come in contact with the movable section 7 when transmitting driving forces to the movable section 7. In the present invention, “contact” refers to a state where constituent elements touch each other but are not coupled to each other.

The movable section 7 includes an intermediate member 11 which is provided on a side of the movable section 7 opposing the base 1, and a mirror section 2 which is provided on a side of the movable section 7 opposite from the intermediate member 11. When the driving force transmitting sections 10a to 10c transmit driving forces to the movable section 7, the intermediate member 11 comes in contact with the protruding portions 34a to 34c. The mirror section 2 has a light reflecting surface 2a for reflecting light (e.g., a light beam). In a state where driving force is not transmitted to the movable section 7, the light reflecting surface 2a is parallel to the XY plane, and the normal direction of the light reflecting surface 2a is the Z axis direction. The planar shape and size of the light reflecting surface 2a are to be designed in various manners depending on the purpose, desired performance, and the like of the actuator 100. In the present embodiment, the light reflecting surface 2a has a hexagonal shape, and each side of the hexagon is about 60 μm.

The driving sections 6a to 6c are located between the mirror section 2 and the base 1, and the protruding portions 34a to 34c are located between the mirror section 2 and the intermediate member 11. The driving sections 6a to 6c each generate a driving force based on an electrical signal supplied from the driving circuit, and, as the protruding portions 34a to 34c press the intermediate member 11 in a direction toward the base 1 in accordance with these driving forces, the movable section 7 makes a displacement relative to the base 1 along the vertical direction (translation along the Z axis direction) as well as a bi-axial tilt relative to the base 1 (tilt around the X axis and the Y axis). As a result of the movable section 7 making such a displacement, the light reflecting surface 2a reflects incident light in a desired direction.

Next, the driving sections 6a to 6c and the movable section 7 will be described in more detail.

The driving sections 6a to 6c include stationary electrodes 4a, 4b and 4c as well as yokes 5a, 5b and 5c. The stationary electrodes 4a to 4c, which are formed by patterning an electrically conductive film of e.g. polycrystalline silicon, are connected to the driving circuit (not shown) and can be set to desired potentials.

Similarly to the stationary electrodes 4a to 4c, the yokes 5a to 5c are also formed of an electrically conductive film such as polycrystalline silicon. The yokes 5a to 5c are generally diamond-shaped planar members which are disposed so as to oppose the stationary electrodes 4a to 4c with a predetermined interspace therefrom, and are disposed in a symmetrical shape such that the three of them together compose a hexagon as a whole. The stationary electrode 4a and the yoke 5a oppose each other; the stationary electrode 4b and the yoke 5b oppose each other; and the stationary electrode 4c and the yoke 5c oppose each other. The yokes 5a to 5c function as movable electrodes. Each of the yokes 5a to 5c is capable of independently translating along the Z direction, which is a direction perpendicular to the plane of the yokes 5a to 5c. The yokes 5a to 5c are connected to the driving circuit as are the stationary electrodes 4a to 4c, but will always be at the ground potential. By applying a predetermined potential to the stationary electrodes 4a to 4c, an electrostatic attraction is generated between the yokes 5a to 5c and the stationary electrodes 4a to 4c, so that the yokes 5a to 5c are pulled toward the stationary electrodes 4a to 4c. Since a voltage can be individually set for each of the stationary electrodes 4a to 4c, the yokes 5a to 5c can be displaced individually in the −Z direction.

The driving force transmitting sections 10a to 10c are provided in the central portions of the faces of the yokes 5a to 5c opposing the mirror section 2 (the +Z side faces). The driving force transmitting sections 10a to 10c are arch-shaped. The driving force transmitting sections 10a to 10c move integrally with the yokes 5a to 5c when the yokes 5a to 5c are displaced along the Z direction.

The intermediate member 11 is a planar member. A central portion of the intermediate member 11 and a central portion of the mirror section 2 are rigidly coupled via a mirror post 14. Each of the arch-shaped driving force transmitting sections 10a to 10c sandwiches a portion of the intermediate member 11. The protruding portions 34a to 34c are provided on the driving force transmitting sections 10a to 10c in such a manner as to oppose the upper face of the intermediate member 11. The protruding portions 34a, 34b and 34c are able to come in contact with contacted portions 12a, 12b and 12c, each of which is a generally planar face of the intermediate member 11. The contacted portions 12a to 12c lie substantially parallel to the light reflecting surface 2a, and oppose the mirror section 2.

When the driving force transmitting sections 10a to 10c move in the −Z direction, the protruding portions 34a to 34c come in contact with the contacted portions 12a, 12b and 12c, thus pushing down the intermediate member 11 in the −Z direction. By allowing the protruding portions 34a to 34c to be located between the mirror section 2 and the intermediate member 11, and driving the yokes 5a to 5c in the direction toward the stationary electrodes 4a to 4c, the mirror section 2 can be displaced in the −Z direction.

By adopting the structure which allows the driving force transmitting sections 10a to 10c to be in contact with the intermediate member 11 without being in direct contact with the mirror section 2, it becomes possible to adopt a process of fabricating the mirror section 2 separately from the other constituent elements, and thereafter connecting the intermediate member 11 with the mirror section 2. Therefore, it is possible to process the mirror section 2 having the light reflecting surface 2a with a high accuracy, through a process which is separate from the fabrication process of the driving sections 6a to 6c.

When the driving force transmitting sections 10a to 10c are displaced in the −Z direction, the protruding portions 34a to 34c and the contacted portions 12a to 12c will be in contact with but not coupled to each other, thus being in a contact (slidable contact) state where they are capable of sliding against each other. If the positional relationship (e.g., relative angles) between the protruding portions 34a to 34c and the contacted portions 12a to 12c should change greatly, the protruding portions 34a to 34c will be able to slide over the contacted portions 12a to 12c. However, in a normal operation range, the protruding portions 34a to 34c will be in contact with the contacted portions 12a to 12c substantially perpendicularly, and thus will not slide. Even when the movable section 7 tilts, the angle between the displacement direction (Z direction) of the driving force transmitting sections 10a to 10c and the normal direction of the contacted portions 12a to 12c will vary only within a predetermined angle (e.g., a few degrees) centered around 0°, and will not become extremely large. Therefore, the protruding portions 34a to 34c will not come in contact with the contacted portions 12a to 12c so obliquely as to slide over the contacted portions 12a to 12c and cause a change in the contact positions between the protruding portions 34a to 34c and the contacted portions 12a to 12c, but rather will always maintain the same positional relationship. This enables accurate control. Moreover, abrasion of the protruding portions 34a to 34c and the contacted portions 12a to 12c due to rubbing between the protruding portions 34a to 34c and the contacted portions 12a to 12c will not occur, so that a highly reliable actuator can be provided.

Moreover, since the amount of displacement of each of the driving force transmitting sections 10a to 10c can be independently set, it is possible to determine the posture of the intermediate member 11 by independently setting the positions along the Z direction of three points (contacted portions 12a to 12c) on the intermediate member 11. Therefore, it is possible to cause the movable section 7 to freely translate in the −Z direction and tilt around the X axis and the Y axis.

The elastic supporting members 13a to 13c are support springs each having an elastic beam which is coupled to the neighborhood of the center of the intermediate member 11. When the intermediate member 11 moves in the −Z direction, the elastic supporting members 13a to 13c undergo elastic deformation, thus generating elastic restoring forces which load the intermediate member 11 in the opposite direction (+Z direction) of the moving direction. Since the contacted portions 12a to 12c are pressed against the protruding portions 34a to 34c by this elastic restoring force, the contacted portions 12a to 12c can surely be placed in contact with the protruding portions 34a to 34c. In the state where the contacted portions 12a to 12c are in contact with the protruding portions 34a to 34c, it is guaranteed that the amount of movement of the driving force transmitting sections 10a to 10c in the −Z direction is equal to the amount of movement of the contacted portions 12a to 12c. Thus, a highly accurate actuator can be provided which allows the displacements of the driving sections 6a to 6c to be surely reflected on the displacement of the movable section 7.

Note that the intermediate member 11 and the elastic supporting members 13a to 13c can be simultaneously formed through the same process, and no special steps such as highly accurately processing the intermediate member 11 alone or processing the intermediate member 11 into a sphere are required. Thus, it is possible to provide a highly reliable actuator at low cost.

Next, an actuator array which is a device incorporating a plurality of actuators 100 will be described.

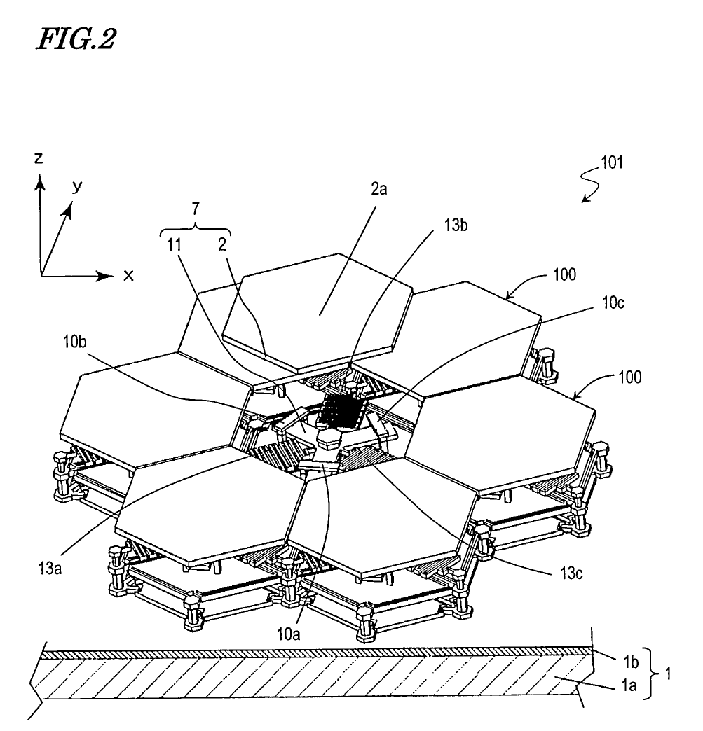

FIG. 2 is an exploded perspective view schematically showing an actuator array 101 of the present embodiment. The actuator array 101 comprises a plurality of actuators 100. The actuator array 101 is a micromirror array in which a plurality of mirror sections 2 are placed in a two-dimensional array, such that the plurality of mirror sections 2 can each be individually displaced. The actuator array 101 is produced by a micromachining technique or a MEMS technique utilizing a semiconductor fabrication process.

In the actuator array 101, a plurality of driving section units are disposed two-dimensionally on the base 1, where each driving section unit is the driving sections 6a to 6c of each actuator 100. The elastic supporting members 13a to 13c and the movable section 7 are provided in association with each driving section unit. Each movable section 7 is supported by the corresponding elastic supporting members 13a to 13c so as to be capable of displacement relative to the base 1. Each driving section unit causes a corresponding one of the plurality of movable sections 7 to be displaced relative to the base 1. When transmitting driving force to a corresponding one of the plurality of movable sections 7, each of the driving force transmitting sections 10a to 10c comes in contact with the corresponding movable section 7 and transmits driving force thereto.

The number of actuators 100 to be comprised in the actuator array 101 may be arbitrary. For example, for the purpose of controlling the wave front of light in the field of adaptive optics, the actuator array 101 comprises 1000 or more actuators 100.

The size along the horizontal direction of a single driving section unit, which combines one set of driving sections 6a to 6c, is about the same as the size of the mirror section 2 or smaller. Therefore, it is possible to densely dispose adjoining mirror sections 2 with a slight interspace of about few μm, without being influenced by the size of the driving section unit; thus, a multitude of mirror sections 2 can be arrayed efficiently.

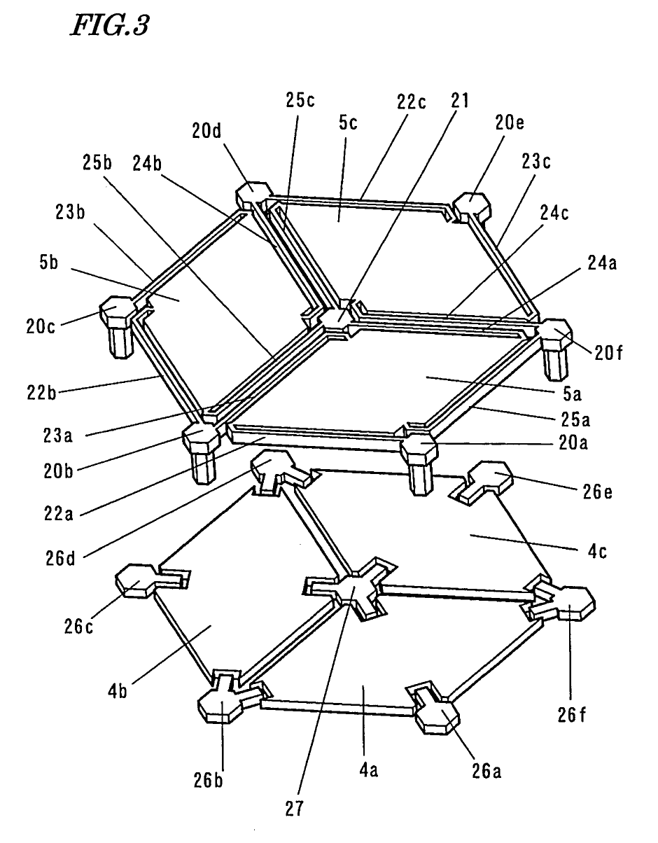

Next, the stationary electrodes 4a to 4c and the yokes 5a to 5c of the actuator 100 (FIG. 1) will be described more specifically. FIG. 3 is an exploded perspective view schematically showing the stationary electrodes 4a to 4c and the yokes 5a to 5c.

The yokes 5a to 5c are supported by the yoke supporting beams 22a to 22c; 23a to 23c; 24a to 24c; and 25a to 25c, with a predetermined gap from the stationary electrodes 4a to 4c. Each of the yoke supporting beams 22a to 25c is an elongated elastic beam which is coupled to a corresponding one of the yoke supporting pillars 20a to 20f and 21. The yoke supporting beams 22a to 25c and the yoke supporting pillars 20a to 21 are formed of the same electrically conductive material as that of the yokes 5a to 5c, and are formed simultaneously with the yokes 5a to 5c. The yoke supporting pillars 20a to 20f are disposed along the outermost periphery of the hexagonal region, whereas the yoke supporting pillar 21 is disposed in the center of the hexagonal region, all of them having an identical shape. Moreover, the yoke supporting pillars 20a to 21 are disposed near the corner portions of the generally diamond-shaped yokes 5a to 5c, such that each of the yokes 5a to 5c is supported by corresponding four of the yoke supporting pillars 20a to 21.

When voltages are applied to the stationary electrodes 4a to 4c and an electrostatic attraction is generated between the stationary electrodes 4a to 4c and the yokes 5a to 5c, the yokes 5a to 5c are pulled and move in the direction (−Z direction) toward the stationary electrodes 4a to 4c. At this time, the yoke supporting beams 22a to 25c undergo elastic deformation, thus generating elastic restoring forces which load the yokes 5a to 5c in the opposite direction (+Z direction) of the moving direction of the stationary electrodes 4a to 4c. The yokes 5a to 5c will be displaced to a position where this elastic restoring force and the electrostatic attraction are at equilibrium.

The supporting pillar bases 26a to 26f and 27 are small electrodes which are provided at lower portions of the respective yoke supporting pillars 20a to 21 and support the yoke supporting pillars 20a to 21. Similarly to the stationary electrodes 4a to 4c, the supporting pillar bases 26a to 27 are formed by patterning an electrically conductive film of polycrystalline silicon, and are connected to the driving circuit (not shown) so as to be maintained at the ground potential. The yoke supporting pillars 20a to 21, the yoke supporting beams 22a to 25c, and the yokes 5a to 5c are formed of an electrically conductive material, and are electrically connected to the supporting pillar bases 26a to 27, thus being maintained at the ground potential.

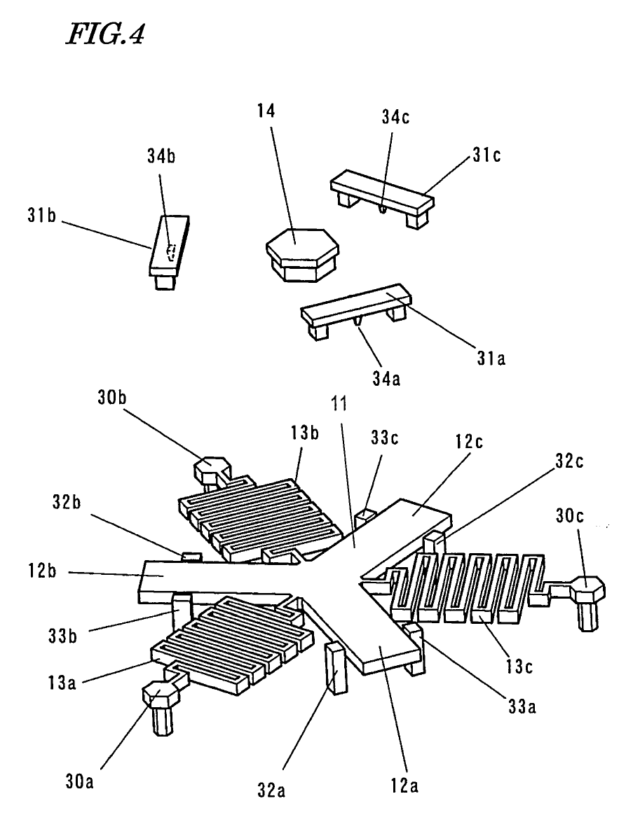

Next, referring to FIG. 4, the intermediate member 11, the elastic supporting members 13a to 13c, and the driving force transmitting sections 10a to 10c will be described more specifically. FIG. 4 is an exploded perspective view schematically showing the intermediate member 11, the elastic supporting members 13a to 13c, and the driving force transmitting sections 10a to 10c.

End portions of the elastic supporting members 13a, 13b and 13c for supporting the intermediate member 11 are coupled to the intermediate member supporting pillars 30a, 30b and 30c. The intermediate member supporting pillars 30a, 30b and 30c are formed so as to be stacked upon, respectively, the yoke supporting pillars 20b, 20d and 20f (FIG. 3). The intermediate member supporting pillars 30a to 30c support the intermediate member 11 via the elastic supporting members 13a to 13c.

The driving force transmitting section 10 includes bridge portions 31a to 31c as well as post portions 32a to 32c and 33a to 33c. The protruding portions 34a to 34c are provided on the bridge portions 31a to 31c so as to oppose the intermediate member 11. Hereinafter, the bridge portion 31a and the post portions 32a and 33a will be described. (Since the structure combining the bridge portion 31b and the post portions 32b and 33b and the structure combining the bridge portion 31c and the post portions 32c and 33c are identical to the structure combining the bridge portion 31a and the post portions 32a and 33a, the descriptions thereof will be omitted).

The post portions 32a and 33a are provided on the yoke 5a (FIG. 3). The bridge portion 31a is located between the light reflecting surface 2a and the intermediate member 11, and supported by the post portions 32a and 33a. An upper end portion of the post portion 32a and an upper end portion of the post portion 33a are linked by the bridge portion 31a, which together constitute an arch-like shape. The post portions 32a and 33a, which are disposed so as to sandwich a portion (near the contacted portion 12a) of the intermediate member 11 with a slight interspace therebetween, restrict the movement of the intermediate member 11 along any direction in the XY plane, while allowing the intermediate member 11 to move only in the Z direction. Moreover, the bridge portion 31a is disposed in such a manner that a portion thereof opposes a portion (near the contacted portion 12a) of the intermediate member 11.

The protruding portion 34a is provided on a face of the bridge portion 31 that opposes the contacted portion 12a. The protruding portion 34a has a tapered shape such that its cross-sectional area gradually decreases toward the contact region of the contacted portion 12a which comes in contact with the protruding portion 34a. When the protruding portion 34a is pushed down in the −Z direction in response to the driving of the driving section 6a, the protruding portion 34a comes in contact with the contacted portion 12a, and if driving is further continued, the protruding portion 34a pushes down the contacted portion 12a in the −Z direction. Since the coupling portion between the protruding portion 34a and the bridge portion 31a has a large cross-sectional area and is highly rigid, the protruding portion 34a is unlikely to be broken. Since the tip of the protruding portion 34a which comes in contact with the contacted portion 12a has a small cross-sectional area, it is possible to realize point contact with the contacted portion 12.

Two effects are obtained by pressing the intermediate member with the protruding portions 34a to 34c 11 via point contact at three points. Firstly, even when the intermediate member 11 is tilted so that the relative angles between the intermediate member 11 and the protruding portions 34 change, there is no fluctuation in the contact position between the intermediate member 11 and the protruding portion 34, and therefore the position on the intermediate member 11 at which driving forces are applied does not fluctuate. As a result, the displacement of the yoke 5 can be more accurately transmitted to the movable section 7, and it is possible to control the movable section 7 with a higher accuracy. Secondly, since the intermediate member 11 is not rigidly coupled to the protruding portions 34a to 34c, no elastic deformation between the intermediate member 11 and the protruding portions 34a to 34c occurs due to changes in the relative angles between the intermediate member 11 and the protruding portions 34a to 34c. In the case where the intermediate member 11 is rigidly coupled to the protruding portions 34a to 34c, when changing the relative angles between the intermediate member 11 and the protruding portions 34a to 34c, extra driving force is required for causing elastic deformation of such rigidly-coupled places, so that a larger electrostatic driving force will be required. There is another problem of crosstalk between the driving sections 6a, 6b and 6c in that, even if it is desired to only drive the contacted portion 12a, the other protruding portions 34b and 34c may be displaced due to counter-forces of elastic deformation which occurs in response to changes in the relative angles between the intermediate member 11 and the protruding portion 34a. Such crosstalk can be suppressed by driving the intermediate member 11 via point contact at three points, thus enabling control with an even higher accuracy.

Next, the intermediate member 11 and the protruding portion 34a will be described more specifically. The descriptions of the protruding portions 34b and 34c will be similar to the description of the protruding portion 34a, and therefore are omitted here. FIG. 5 is a cross-sectional view schematically showing the intermediate member 11 and the protruding portion 34a.

The protruding portion 34a is provided on a face of the bridge portion 31a that opposes the contacted portion 12a. The protruding portion 34a has a tapered cross-sectional shape such that its cross-sectional area decreases toward the contacted portion 12a. In a state where the driving force transmitting section 10a (FIG. 1) does not transmit any driving force to the movable section 7 (i.e., a state where no voltage is applied to the stationary electrode 4a (FIG. 1)), the driving force transmitting section 10a is not in contact with, but is away from, the movable section 7. In other words, in a state where the driving force transmitting section 10a does not transmit any driving force to the movable section 7, the protruding portion 34a and the contacted portion 12a are of such a positional relationship that they are not in contact with each other, but are away from each other with a small interspace (e.g., a few micrometers) therebetween. When the driving section 6a is driven, the protruding portion 34a is displaced in the −Z direction to come in contact with the contacted portion 12a, and further pushes down the contacted portion 12a in the −Z direction.

At least either one (and both in the present embodiment) of the protruding portions 34a to 34c and the intermediate member 11 includes a sticking prevention film 40. The sticking prevention film 40 is a protection film which prevents a phenomenon called sticking, where the protruding portions 34a to 34c and the contacted portions 12a to 12c remain in contact with and sucked onto each other. The sticking prevention film 40 is a monomolecular protection film (Self-Assembled monolayer Coating), for example. By soaking the driving sections 6a to 6c and the entire intermediate member 11 (FIG. 1) in a solution of a monomolecular protection film material, it is possible to form the sticking prevention film 40 over the entire surface including the protruding portions 34a to 34c and the contacted portions 12a to 12c. The thickness of the sticking prevention film 40 may be arbitrary, and is a few nm, for example (the thickness is exaggerated in FIG. 5). Thus, sucking and fixing between the protruding portions 34a to 34c and the contacted portions 12a to 12c is prevented. If the protruding portions 34a to 34c stay sucked to the contacted portions 12a to 12c, a pivot resistance will occur when the intermediate member 11 is tilted, thus resulting in a greater electrostatic attraction being required for tilting the intermediate member 11, and crosstalk between the driving sections 6a to 6c. However, the sticking prevention film 40 prevents pivot resistance when tilting the intermediate member 11, so that a highly accurate control can be realized with a low voltage.

Next, the operation of the actuator 100 will be described more specifically.

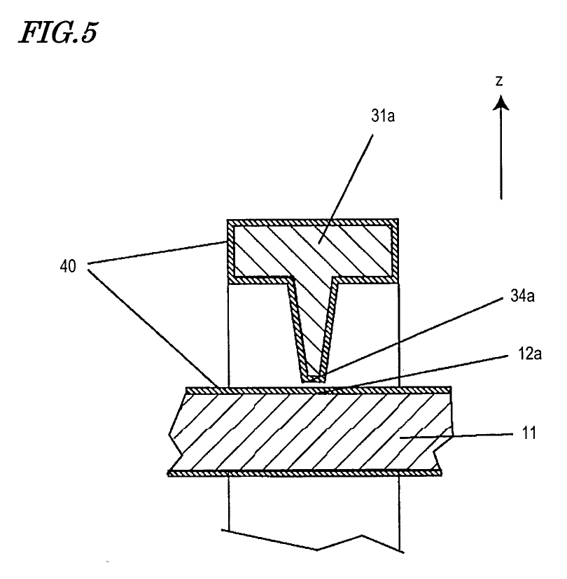

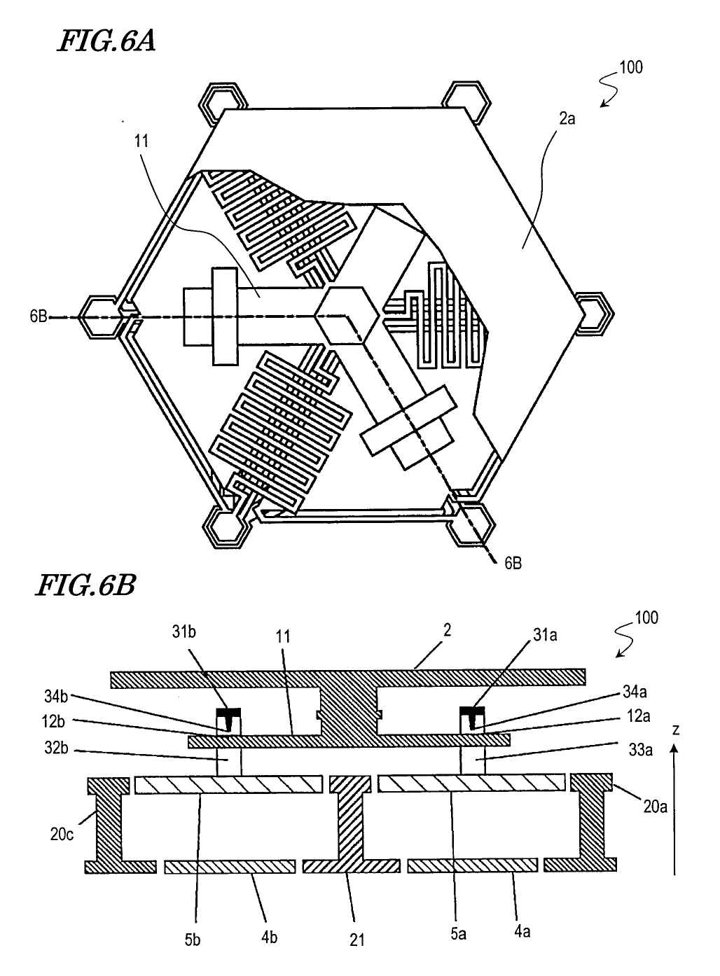

FIG. 6A is an upper plan view of the actuator 100. FIG. 6B is a cross-sectional view of the actuator 100 taken along line 6B-6B shown in FIG. 6A, showing a cross section following along the intermediate member 11 through the center of the actuator 100. FIG. 6B shows the actuator 100 in an unpowered state.

Referring to FIG. 6B, in a state where no power is supplied to the stationary electrodes 4a and 4b, no electrostatic attraction is generated between the stationary electrodes 4a and 4b and the yokes 5a and 5b, so that the yokes 5a and 5b are in their initial positions (i.e., highest positions along the Z direction), and the upper faces of the yokes 5a and 5b are located at the same height as the upper faces of the yoke supporting pillars 20a to 21. When the yokes 5a and 5b are in their initial positions, the lower end portions of the protruding portions 34a and 34b are located at a height where they oppose the intermediate member 11 with a slight interspace therebetween.

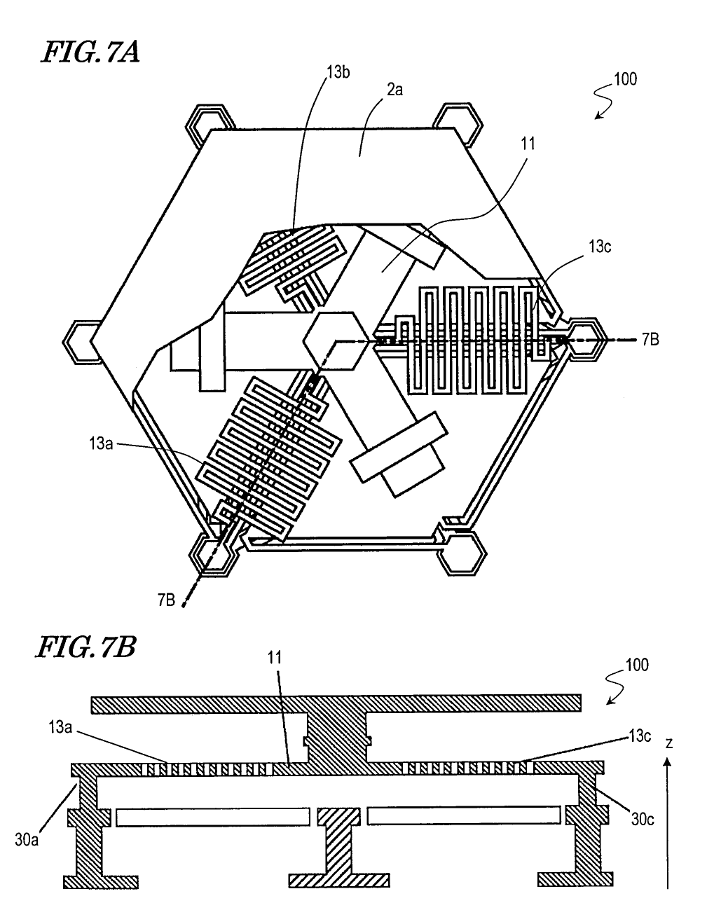

FIG. 7A is an upper plan view of the actuator 100. FIG. 7B is a cross-sectional view of the actuator 100 along line 7B-7B shown in FIG. 7A, showing a cross section following along the elastic supporting member 13a and 13c through the center of the actuator 100. FIG. 7B shows the actuator 100 in an unpowered state.

Referring to FIG. 7B, in an unpowered state where none of stationary electrodes 4a to 4c is powered, the intermediate member 11 is in contact with none of the protruding portions 34a to 34c, and the elastic supporting members 13a to 13c supporting the intermediate member 11 are not deformed. At this time, the upper faces of the intermediate member 11 and the elastic supporting members 13a to 13c are located at the same height along the Z direction as the upper faces of the intermediate member supporting pillars 30a to 30c (FIG. 4). The position along the Z direction of the intermediate member 11 in this unpowered state is the highest position along the Z direction that the intermediate member 11 can take.

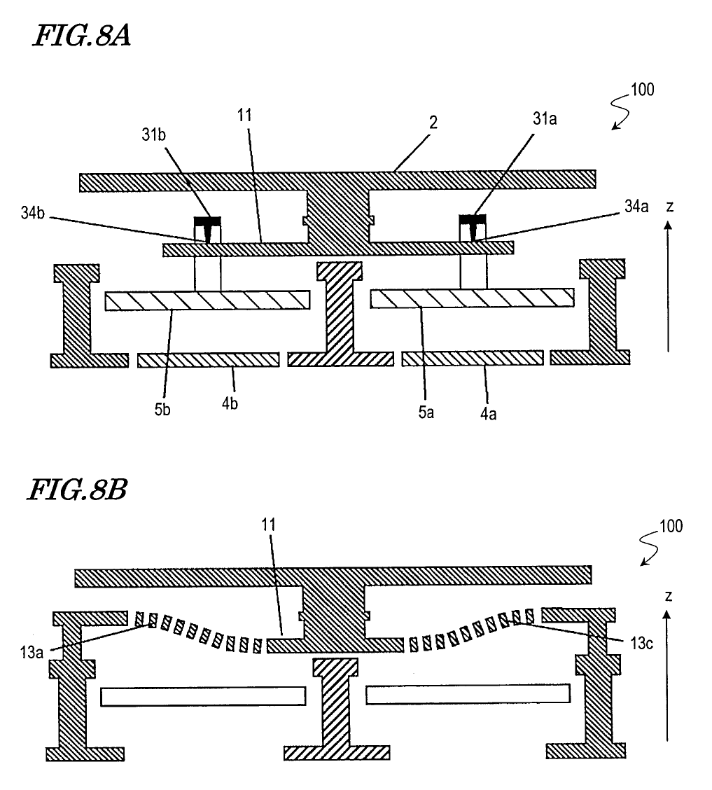

Next, a maximum displacement state of the actuator 100 will be described. FIG. 8A is a cross-sectional view of the actuator 100 along line 6B-6B shown in FIG. 6A. FIG. 8B is a cross-sectional view of the actuator 100 along line 7B-7B shown in FIG. 7A.

FIG. 8A and FIG. 8B show a maximum displacement state where the same voltage is applied to all of the three stationary electrodes 4a to 4c so that the yokes 5a to 5c are moved farthest in the −Z direction, the yokes 5a to 5c being at the lowest possible position along the Z direction. Since the same voltage is applied to all of the three stationary electrodes 4a to 4c, the protruding portions 34a to 34c (FIG. 1) are all displaced by the same distance in the −Z direction, thus coming in contact with the intermediate member 11 and causing the intermediate member 11 to translate in the −Z direction. As a result, the mirror section 2 coupled to the intermediate member 11 is also simultaneously translated. The voltage which is being applied to the stationary electrodes 4a to 4c in this state of being displaced farthest in the −Z direction is defined as the maximum voltage. By varying the voltage to be applied to the stationary electrodes 4a to 4c from 0 to the maximum voltage, the position along the Z direction of the protruding portions 34a to 34c can be freely set between the lowest position (FIG. 8A) and the highest position (FIG. 6B), whereby the position along the Z direction of the movable section 7 can also be displaced to a desired position.

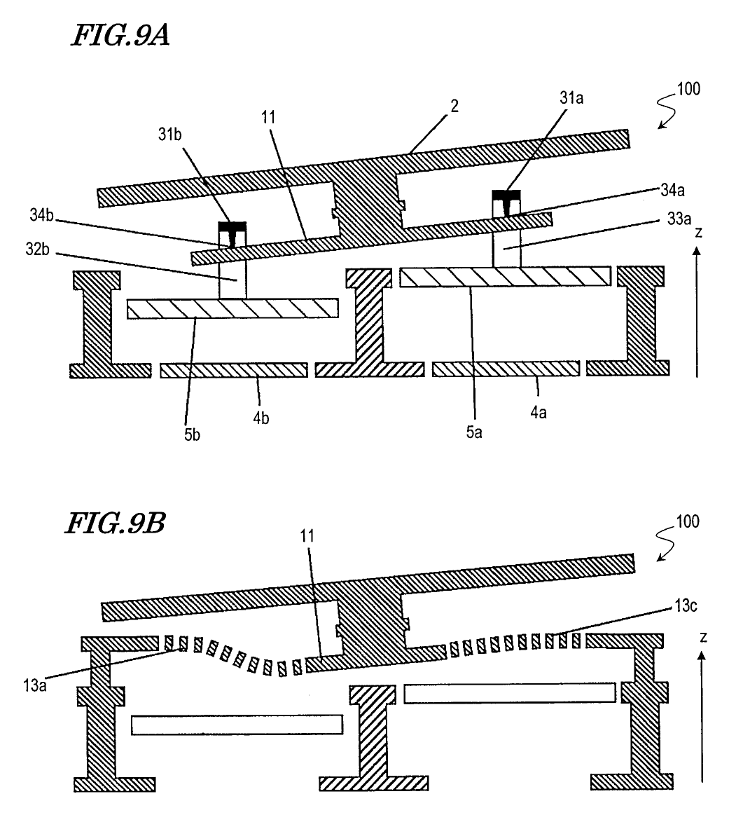

Next, a tilted state of the actuator 100 will be described. FIG. 9A is a cross-sectional view of the actuator 100 taken along line 6B-6B shown in FIG. 6A. FIG. 9B is a cross-sectional view of the actuator 100 taken along line 7B-7B shown in FIG. 7A.

FIG. 9A and FIG. 9B show a tilted state of the actuator 100 where, among the three stationary electrodes 4a to 4c, a small voltage is applied to the stationary electrodes 4a and 4c (not shown) whereas the maximum voltage is applied to the stationary electrode 4b. The protruding portions 34a and 34c (FIG. 1) are moved in the −Z direction so as to come in contact with the intermediate member 11 and press the contacted portions 12a and 12c (FIG. 1) slightly in the −Z direction, thus determining the position along the Z direction of the intermediate member 11 near the contacted portions 12a and 12c. On the other hand, the protruding portion 34b is greatly moved in the −Z direction, thus greatly pushing down the contacted portion 12b in the −Z direction. As a result, the heights along the Z direction of three points on the intermediate member 12 (contacted portions 12a to 12c) are set so as to tilt the movable section 7. At this time, since the intermediate member 11 is loaded in the +Z direction by the elastic supporting member 13, the intermediate member 11 and the protruding portions 34a to 34c do not come apart, so that it is always possible to control the posture of the intermediate member 11 based on the Z direction positions of the protruding portions 34a to 34c. Moreover, by individually changing the voltages on the stationary electrodes 4a to 4c, the positions of the protruding portions 34a to 34c can be set independently, so that the intermediate member 11 can be arbitrarily tilted and translated within a stroke from the highest position to the lowest position.

Since the intermediate member 11 is prevented by the post portions 32a to 33c from being displaced along a horizontal direction (direction parallel to the XY plane), relative displacements between the intermediate member 11 and the protruding portions 34a to 34c do not occur along the horizontal direction. Therefore, it is possible to provide a highly reliable actuator in which abrasion between the intermediate member 11 and the protruding portions 34a to 34c does not occur.

Although the protruding portions 34a to 34c will only translate along the Z direction and will not tilt, the intermediate member 11 does tilt. Therefore, when the intermediate member 11 tilts, the relative angles between the intermediate member 11 and the protruding portions 34a to 34c vary. However, since the intermediate member 11 and the protruding portions 34a to 34c are in point contact and not rigidly coupled, no elastic deformation between the intermediate member 11 and the protruding portions 34a to 34c occurs.

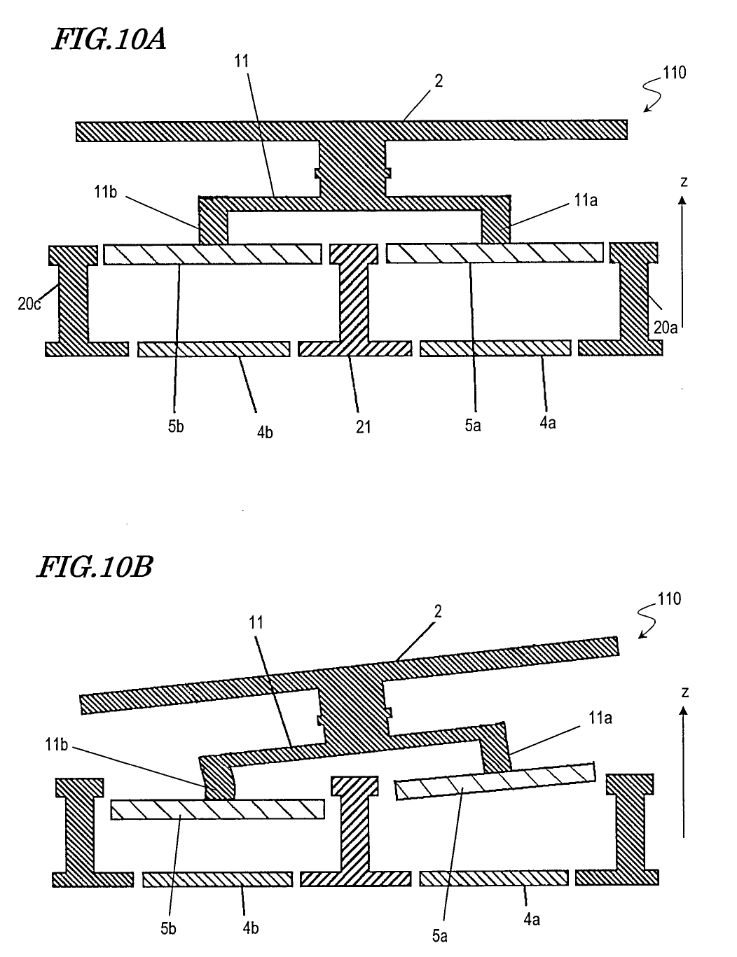

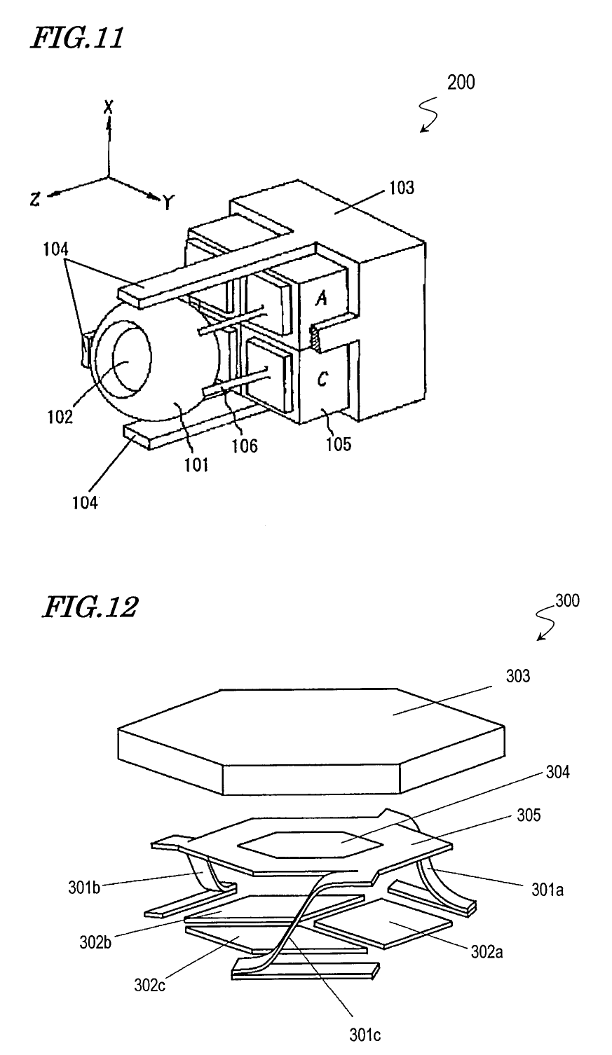

Referring to FIG. 10A and FIG. 10B, a tilted state of an actuator in which the intermediate member 11 and the yokes 5a to 5c are rigidly coupled will be described. FIG. 10A and FIG. 10B are cross-sectional views of an actuator 110 in which the intermediate member 11 and the yokes 5a to 5c are rigidly coupled. The intermediate member 11 is rigidly coupled to the yokes 5a, 5b and 5c at rigid-coupling portions 11a, 11b and 11c (where 11c is not shown). FIG. 10A shows the actuator 110 in an unpowered state. FIG. 10B shows a tilted state of the actuator 110 where the maximum voltage is applied to the stationary electrode 4b in order to tilt the intermediate member 11.

Referring to FIG. 10B, when the maximum voltage is applied to the stationary electrode 4b so as to tilt the intermediate member 11, the relative angle between the intermediate member 11 and the yoke 5b changes so as to cause elastic deformation of the rigid-coupling portion 11b. Therefore, as compared to the actuator 100, the actuator 110 will require extra driving force for causing elastic deformation of the rigid-coupling portion 11b, so that a larger electrostatic driving force will be required. Moreover, crosstalk between the driving sections 6a, 6b and 6c will occur such that, when the intermediate member 11 is tilted by applying the maximum voltage to the stationary electrode 4b, the yokes 5a and 5c which are rigidly coupled to the intermediate member 11 will be tilted together with the intermediate member 11. Referring to FIG. 10B, depending on whether the yoke 5a is not tilted or the yoke 5a is tilted, the magnitude of electrostatic attraction occurring between the yoke 5a and the stationary electrode 4a will differ even if the same size of voltage is being applied to the stationary electrode 4a. When such a crosstalk occurs to allow the movement of a given yoke to affect the amounts of movement of the other yokes, it is necessary to perform a correction control for correcting for the unnecessary displacement due to the crosstalk, so that the amount of data for controlling the posture of the actuator will become enormous. Especially in the case of a device (e.g., a micromirror array) comprising a large number of actuators, the amount of data for correcting for the displacement due to crosstalk will become enormous. This may cause a tremendous increase in cost and a decrease in the driving speed of the microactuator.

As shown in FIG. 9A, in the actuator 100 of the present embodiment, the intermediate member 11 and the protruding portions 34a to 34c are not rigidly coupled but in point contact. Therefore, elastic deformation as described with reference to FIG. 10B does not occur, so that any counter-force due to elastic deformation can be eliminated. Therefore, the electrostatic driving force necessary for driving can be kept small. Moreover, since the yokes 5a to 5c do not tilt even if the intermediate member 11 is tilted, unnecessary displacement of the yokes 5a to 5c is suppressed and the yokes 5a to 5c and the stationary electrodes 4a to 4c can be maintained in a parallel relationship, whereby the aforementioned crosstalk can be suppressed. Therefore, it is possible to perform a highly accurate control with a smaller amount of data.

Moreover, when the protruding portions 34a to 34c are displaced in the −Z direction, the protruding portions 34a to 34c are in contact with the intermediate member 11 substantially perpendicularly. Even when the intermediate member 11 is tilted, the angle between the displacement direction (Z direction) of the driving force transmitting sections 10a to 10c and the normal direction of the contacted portions 12a to 12c will vary only within a predetermined angle (e.g., a few degrees) centered around 0°, and will not become extremely large. Therefore, the protruding portions 34a to 34c will not come in contact with the contacted portions 12a to 12c so obliquely as to slide over the contacted portions 12a to 12c and cause a change in the contact positions between the protruding portions 34a to 34c and the contacted portions 12a to 12c, but rather will always maintain the same positional relationship. This enables accurate control. Moreover, abrasion of the protruding portions 34a to 34c and the contacted portions 12a to 12c due to rubbing between the protruding portions 34a to 34c and the contacted portions 12a to 12c will not occur, so that a highly reliable actuator can be provided.

Although the protruding portions 34a to 34c have a tapered shape in the present embodiment, they do no need to have a tapered shape. The tip shape of the protruding portions 34a to 34c does not need to be planar, but may be made into a curved surface having a small radius of curvature R, thus realizing point contact with the intermediate member 11.

In the present embodiment, the driving sections 6a to 6c are illustrated to be electrostatic-type driving sections which only generate electrostatic attractions for pulling the yokes toward the stationary electrodes. Alternatively, driving sections which are capable of displacing the yokes in both upper and lower directions, e.g., piezoelectric-type driving sections, may be used so as to press the intermediate member 11 on both the upper face and the lower face via point contact.

### INDUSTRIAL APPLICABILITY

An actuator according to the present invention and a device incorporating such actuators can be suitably used in the fields of optical devices and optical disk apparatuses which perform aberration correction, optical scanning, spectroscopy, and the like. They are also suitably used in fields such as high-frequency circuits (e.g., tunable capacitors), flow control devices (e.g., variable flow paths), and biotechnology. An actuator according to the present invention and a device incorporating such actuators can be used especially suitably in the fields of mechanical optical switches for reflecting a light beam so as to enter a photoelectric device or an optical fiber in a predetermined position, as well as micromirror arrays for aberration correction.

1. An actuator comprising:
a base;
a movable section capable of displacement relative to the base;
an elastic supporting member for supporting the movable section so as to allow the movable section to make a displacement relative to the base; and
a plurality of driving sections for causing the movable section to be displaced relative to the base, wherein,
each of the plurality of driving sections includes a driving force transmitting section which comes in contact with the movable section when transmitting driving force to the movable section, and
the movable section includes an intermediate member provided on a side of the movable section opposing the base, the intermediate member coming in contact with the driving force transmitting section when the driving force is transmitted to the movable section.

2.-5. (canceled)

6. The actuator of claim 1, wherein,
the driving force transmitting section includes a protruding portion which comes in contact with the intermediate member when transmitting the driving force to the movable section, and
at least one of the protruding portion and the intermediate member includes a sticking prevention film.

7. The actuator of claim 1, wherein,
the movable section further includes a light reflecting surface provided on a side of the movable section opposite from the intermediate member.

8. The actuator of claim 1, wherein,
the driving force transmitting section includes a protruding portion which comes in contact with the intermediate member when transmitting the driving force to the movable section, and
the movable section is displaced when the protruding portion presses the intermediate member in a direction toward the base.

9. The actuator of claim 8, wherein,
the movable section further includes a light reflecting surface provided on a side of the movable section opposite from the intermediate member, and
the protruding portion is located between the light reflecting surface and the intermediate member.

10. The actuator of claim 9, wherein,
the driving force transmitting section further includes:
post portions sandwiching a portion of the intermediate member with an interspace from the intermediate member; and
a bridge portion located between the light reflecting surface and the intermediate member and being supported by the post portions, and
the protruding portion is provided on the bridge portion.

11. A device comprising:
a base;
a plurality of movable sections capable of displacement relative to the base;
a plurality of elastic supporting members for each supporting a corresponding one of plurality of movable sections so as to allow the movable section to make a displacement relative to the base; and
a plurality of driving sections for causing respective ones of the plurality of movable sections to be displaced relative to the base, wherein,
each of the plurality of driving sections includes a driving force transmitting section which, when transmitting driving force to a corresponding one of the plurality of movable sections, comes in contact with the corresponding movable section, and
each of the plurality of movable sections includes an intermediate member provided on a side of a corresponding one of the plurality of movable sections opposing the base, the intermediate member coming in contact with the driving force transmitting section when the driving force is transmitted to the corresponding movable section.

12. An actuator comprising:
a base;
a movable section capable of displacement relative to the base;
an elastic supporting member for supporting the movable section so as to allow the movable section to make a displacement relative to the base; and
a plurality of driving sections for causing the movable section to be displaced relative to the base, wherein,
each of the plurality of driving sections includes a driving force transmitting section which comes in contact with the movable section when transmitting driving force to the movable section;
the driving force transmitting section is in slidable contact with the movable section when transmitting the driving force to the movable section; and
a region of the movable section that is in slidable contact with the driving force transmitting section is planar.
